(19) United States
(12) Patent Application Publication
(10) Pub. No.: US 2011/0055199 A1
(43) Pub. Date: Mar. 3, 2011

(54) JOIN ORDER OPTIMIZATION IN A QUERY OPTIMIZER FOR QUERIES WITH OUTER AND/OR SEMI JOINS

(76) Inventors: Kashif A. Siddiqui, Round Rock, TX (US); Awny K. Al-Omari, Cedar Park, TX (US)

(21) Appl. No.: 12/547,361

(22) Filed: Aug. 25, 2009

(51) Int. Cl. G06F 17/30

(52) U.S. Cl. 707/714; 707/E17.017

(57) ABSTRACT

A system and method for join order optimization in a query optimizer is disclosed. The method includes receiving a query having a plurality of join operators, including at least one multi-way join between relational operators in the query tree. The join operators include at least one outer-join and/or semi-join. The multi-way-join is transformed to a multi-join operator with a plurality of join back bone children representing the relational operators. The dependencies that occur between the join back bone children are tracked. Join order validity is evaluated based on the tracked dependencies. One or more multi-join rules are applied to the multi-join operator sufficient to generate at least one join subtree when at least one join subtree is determined to have a valid join order.

### BACKGROUND

Structured Query Language (SQL) databases have state of the art compilers that are designed to handle complex queries. An SQL compiler typically goes through several phases to generate an efficient execution plan. First, a query is passed to a parser where syntactic checking is performed and an initial query tree is built. Next, a binder performs semantic checks and binds query variables to database objects. This is followed by a normalizer phase, where subquery transformation and other unconditional query transformations take place. The normalizer transforms the query into a canonical tree form before passing the tree to a query optimizer to determine the execution strategy.

One type of query optimizer is a rule driven optimizer. The search space or search algorithm can be changed by simply adding, removing, or changing rules. This offers a great deal of extensibility. Adding a new optimization feature could be as easy as adding a new rule.

However, a weakness of this type of query optimizer is in performance. Historically, the rule driven optimizer has used a set of rules (commutative and left-shift rules) to exhaustively enumerate all the possible join orders. Although this approach uses the principle of optimality to significantly reduce the complexity of the exhaustive search algorithm, the complexity remains exponential even when the search space is limited to zigzag and left linear trees. The explosion of the explored search space evidently manifests itself as a compile time explosion.

Optimizer design has relied on cost-based pruning and lower bound limit as the potential mechanism to control the search space (this is the “bound” in “branch and bound”). The goal has been to use a cost limit, based on the processing cost of the cheapest plan computed so far, to prune parts of the search space that have a lower bound above the cost limit. Although the technique was helpful in reducing compile time, the pruning rate is far less than what is desired to control the exponentially increasing search space.

Compiling a complex query within a short period of time is, by itself, not the challenge. The real challenge is to compile it within a reasonable period of time, yet produce a plan with quality comparable to that generated by the expensive exhaustive search.

Reducing compile time and improving plan quality are the two ever-competing goals for any SQL compiler. More often than not, an attempt to improve one of the two will have a negative effect on the other. Hence, a discussion of compiler performance is only relevant in the context of plan quality.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a flow chart that illustrates an SQL database compiler flow process in accordance with an embodiment;

FIG. 2 illustrates an example of multi-join rewrite transformation in a query analyzer in accordance with an embodiment;

FIG. 3 illustrates an example of a multi-join rule producing a fully specified join tree in accordance with one embodiment;

FIG. 4 illustrates an example of a multi-join rule producing a partially specified join tree in accordance with one embodiment;

FIG. 5 illustrates an example of a multi-join that can be transformed into any left linear ordering of the tables in the query in accordance with one embodiment;

FIG. 6 illustrates an example of a multi-join with a split subset applied to form a valid join order based on tracking dependency information in accordance with an embodiment; and

FIG. 7 illustrates a flow chart depicting a method for join order optimization in a query optimizer in accordance with an embodiment.

Reference will now be made to the exemplary embodiments illustrated, and specific language will be used herein to describe the same. It will nevertheless be understood that no limitation of the scope of the invention is thereby intended.

### DETAILED DESCRIPTION

A framework for join order optimization via the use of a multi-join operator and multi-join rules are disclosed. More particularly, the framework of the multi-join rules is extended to include the use of outer-joins, semi-joins, and anti-semi-joins. The capacity to include these types of joins in a query optimization significantly enhances the ability to both reduce the overall compile time and improve the plan quality for the class of queries that contain these types of joins.

A query optimizer works by enumerating different alternative plans from the plan search space. Search space denotes all possible execution plans for a query. The plan with the lowest estimated cost is typically selected. However, exhaustively enumerating alternative plans towards determining the plan having the lowest cost can be time consuming.

In general, solving the problem for an arbitrary query can prove quite difficult and cumbersome. A query tree can have a complex structure of nested sub-queries and various join, group by, union, or scan operators. Join permutations are the main reason behind the explosion of the exhaustive search space. A multi-way join between multiple expressions can generate an exponential number of join expressions to be considered in the exhaustive scheme. A Multi-Join operator is a representation of a multi-way join. Each left linear sequence of joins in a query tree is referred to as a Join Back Bone (JBB). Each JBB is represented as a Multi-Join operator.

During the query analysis phase, predicates are analyzed and relationships among query tables and join children are examined. Query analysis performs two important tasks among others; Join Backbone (JBB) Analysis, and Table Connectivity Analysis. The JBB Analysis task collects information about the join operators and their children to facilitate complex join tree transformations efficiently. The Table Connectivity Analysis task collects predicate relationship information between the tables (and columns) in the query, in order to assist heuristic decisions based on available indexes and natural sort orders and partitioning. In addition to the two tasks above, other analysis tasks useful for improving optimization decisions can be added as part of the query analysis phase.

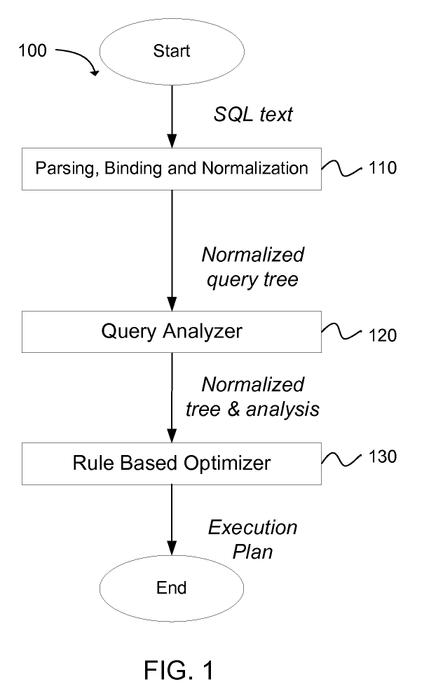

As an example, consider FIG. 1 which illustrates a high level block diagram of an exemplary method generally at 100 in accordance with one embodiment. In this example, the system 100 receives SQL text and performs, parsing, binding and normalization with one or more components at 110. The output of this process is a normalized query tree that is provided to a query analyzer 120 which processes the normalized query tree to produce a normalized and analyzed tree to a rule based optimizer 130 which produces an execution plan.

More specifically, with regard to the query analyzer 120, consider the following. During the query analysis phase, predicates are analyzed and relationships among query tables and join children are examined. Query analysis performs two important tasks among others; Join Backbone (JBB) Analysis, and Table Connectivity Analysis. The JBB Analysis task collects information about the join operators and their children to facilitate complex join tree transformations efficiently. The Table Connectivity Analysis task collects predicate relationship information between the tables (and columns) in the query, in order to assist in heuristic decisions based on available indexes, natural sort orders and partitioning. In addition to the two tasks above, other analysis tasks useful for improving optimization decisions can be added as part of the query analysis phase.

The notion of the join backbone is important in the query analyzer. The purpose of JBB Analysis is to identify the join backbones and collect join connectivity information between each of the join backbone children. The notion of the join backbone, its children, and subsets are described below.

Join Backbone (JBB)

A join backbone refers to a multi-way join between two or more relational expressions. These relational expressions are referred to as the Join Backbone children (JBBCs). The JBB is defined by the JBB children as well as the join types and join predicates between these children. After the normalizer has normalized the query tree, the tree is analyzed to identify the join backbones. The JBB is set during the analysis phase and remains unchanged during the optimization process. The JBB can be thought of as an invariant representation of the original join nodes, which is independent of the relative order of these nodes in the initial tree. Note that a query may have several join backbones.

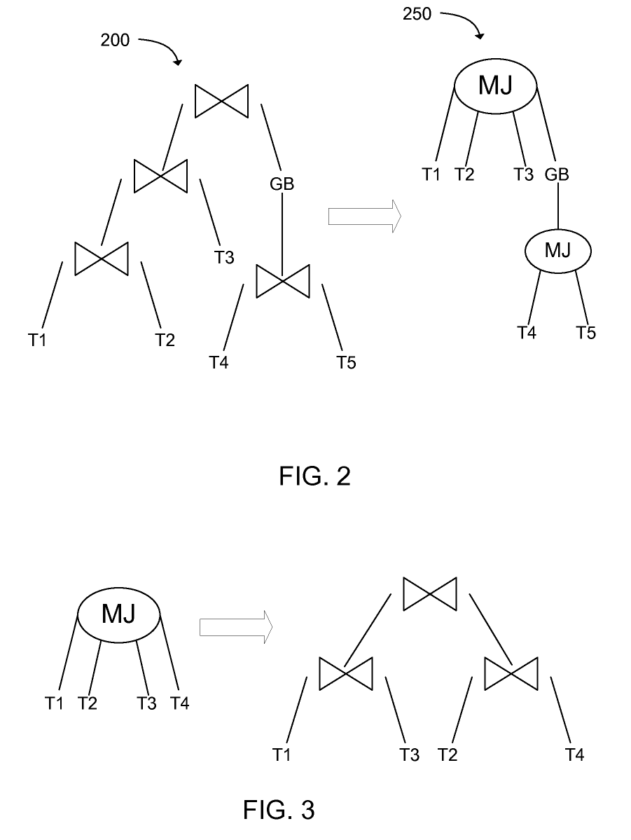

As an example, consider FIG. 2. Here, the query tree 200 has a major join backbone represented by the left linear sequence of join operators (represented by the bow tie icons) joining T1, T2, T3, and the Group By (GB) subquery. In addition there is a second join backbone in the subquery joining T4 and T5.

Join Backbone Child (JBBC)

A join backbone child (JBBC) refers to one of the joined expressions in the join backbone. Starting from the normalizer left linear join tree, the JBBCs are the right children of all of the join nodes as well as the left child of the left-most join node. It is important to note that not every JBBC is a table scan operator and vice versa. In the example of FIG. 2, the first JBB has four JBBCs, namely, T1, T2, T3, and the group by operator. The second JBB has two JBBCs; T4 and T5.

Multi-Join Rules

The Multi-Join is a logical relational operator that represents a multi-way join between multiple relational operators. The Multi-Join offers a flat canonical representation of an entire join subtree. Unlike regular binary join expressions, the Multi-Join expression can have a variable number of children (joined expressions). The number of children of the Multi-Join can be two or more. The Multi-Join expression contains all the necessary information to create binary join subtrees that are equivalent to the represented multi-way join relations.

Multi-Joins are first created during a Multi-Join Rewrite step in the query analyzer prior to the query optimization phase. Each left linear join subtree that is associated with a JBB during analysis phase is compacted into a single Multi-Join node with as many children as the JBBCs of that JBB. This new Multi-Join node represents a multi-way join between the JBBC expressions in an equivalent manner to the original join tree.

FIG. 2 also illustrates an example of the application of a Multi-Join Rewrite on the query tree 200. The query tree 200 is initially received from a parser in the compiler. It is then the job of the optimizer's Multi-Join rules to transform and decompress these nodes into a join representation, as illustrated in the graphical illustration 250. The Multi-Join operator contains all information needed to create expressions equivalent to the original join tree.

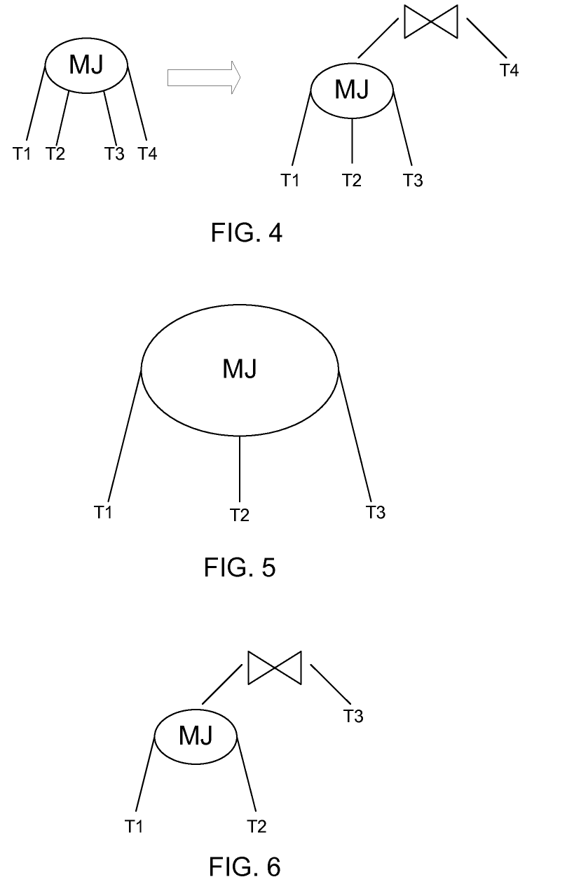

Multi-Join Rules are transformation rules that apply to a Multi-Join expression and generate one or more join subtrees. The generated subtree could have a fully or partially specified join order/shape. In a fully specified join subtree, such as one shown in FIG. 3, all leaves are JBBC expressions (which were children of the original Multi-Join). In a partially specified subtree, one or more leaves is itself a Multi-Join that joins a subset of the original Multi-Join children, an example of which is shown in FIG. 4. Recursive application of Multi-Join Rules result eventually in a set of fully specified join subtrees.

Rules that are applied to multi-join operators have been used to limit the exponential increase in the complexity of enumerating the different alternative plans of the plan search space. By focusing on solving the combinatorial problem within each JBB, the overall problem can be significantly simplified. Rules can be applied on the entire JBB (or part of it), generating output in the form of a fully or partially specified join subtree.

Intelligent enumeration of the join order search space by applying a set of Multi-Join rules to Multi-Join operator(s) has been successful in significantly reducing the size of the search space, thereby decreasing the overall compile time. However, the applicability of the Multi-Join operator and associated Multi-Join rules has been limited to queries with inner-non-semi-joins due to their symmetry. All other join types were considered spoilers. No multi-join operators were formed for queries that contained any join types except for inner-non-semi-joins, therefore the multi-join optimization rules could not be applied.

This is because the join order produced for a query containing only symmetric joins can join the children of the multi-join operator in any order. In other words, there were no dependencies between the children.

For example, consider the following query:

select t1.a

from

t1

inner join

t2

on t1.b=t2.b

inner join

t3

on t1.c=t3.c

The query results in the graphical illustration of the multi-join operator that is illustrated in FIG. 5. For simplicity, only left linear join orderings of the tables in the query are considered. Based on the definitions mentioned above (i.e. all JBBCs have to be connected via inner-non-semi joins), the multi-join illustrated in FIG. 5 can be transformed into any left linear ordering of the tables in the query. Some orderings may have cross products, but they are still legal or valid in that they maintain the semantics of the original query. In total, 3 factorial (3!) different left linear orderings are possible.

If a query had a left-outer join, semi-join, or Tuple Substitute Join (TSJ), then no multi-join was produced in the query analyzer. Consider, for example, the following query:

select t1.a

from

t1

left join

t2

on t1.b=t2.b

inner join

t3

on t1.c=t3.c

Previously, the above query could not be transformed to use multi-joins due to the presence of the left join, which was considered a spoiler. The inability to create a multi-join operator disallows the use of multi-join transformation rules to reduce the overall compile time and improve the plan quality.

Unlike inner joins, changing the order of the operands for a left outer join changes the semantics of the operation. Essentially, asymmetric joins such as left joins, semi joins, and anti-semi joins are non-commutative and non-associative operators. For example, consider the following query:

select t1.a

from

t1

left outer join

t2

on t1.c1=t2.c2

In this scenario, there is only one join ordering that implements the left outer join (LOJ) operator listed in the query. That is, where table 1 (t1) is the left operand and table 2 (t2) is the right operand. From the example above, the left outer join is non-commutative. The commutative relationship (t1 LOJ t2)==(t2 LOJ t1) does not hold. The left outer join is also non associative. The associativity relationship (t1 LOJ (t2 LOJ t3))==(t1 LOJ t2) LOJ t3) does not hold.

Given these facts, any join ordering involving table 1 (t1) left outer join table 2 (t2) would have to make sure that table 1 is joined before table 2. Essentially, table 2 has a dependency on table 1 and can only be joined after table 1. The prior approaches dealt with the use of multi-join operator and multi-join rules for queries in which join operands can be joined in any order. The rules can be enhanced to allow the use of the multi-join operator in the presence of asymmetric joins having dependencies.

When outer-joins and semi-joins are introduced into the multi-join framework, the join order produced by a multi-join rule for any given multi-join has to respect the dependencies between the children of the multi-join operator. These dependencies result from the join type (i.e. left-outer, semi-join, or anti-semi-join) that connects the child to the JBB. The ability to respect the dependencies between the Join Back Bone Children (JBBCs) allows for left-outer-joins and semi-joins to be part of the JBB.

The ability to accommodate left-outer-joins and semi-joins in the Multi-Join framework can be divided into the following two high level components: (1) capturing and representing the dependency information; and (2) using dependency information for enumerating join orders that satisfy the dependencies.

To illustrate, consider the same query as previously mentioned:

select t1.a

from

t1

left join

t2

on t1.b=t2.b

inner join

t3

on t1.c=t3.c

This query can result in the multi-join shown in the graphical illustration in FIG. 5. To accommodate the left join, dependency information can be tracked to guide in the creation of valid join orders. Based on the representation shown in FIG. 5, and using the dependency information, the following three left linear join orders can be enumerated (starting from the left most):
T1 Left Join T2 Inner Join T3;
T1 Inner Join T3 Left Join T2; and
T3 Inner Join T1 Left Join T2.

The following dependency information can be stored for each JBBC, or in other words, for each child of the multi-join.
T1
   successors: {T2}
   predecessors: { }
T2
   successors: { }
   predecessors {T1}
T3
   successors: { }
   predecessors; { }

Only the left linear join sequences are considered for simplicity. Any join ordering produced should respect the dependencies. The predecessors of a JBBC should be before the JBBC in the join sequence. The successors of a JBBC should be after the JBBC in the join sequence.

Following these rules, the search space of alternate join orderings can be enumerated, where each join ordering is valid. In other words, only those join orderings that meet the dependency requirements caused by the left joins, semi-joins and anti-semi joins in the query will be included in the search space. It should be noted that the rules to add semi-joins and anti-semi-joins differ from the rules to add left-outer-joins.

The ability to include each valid join ordering in the search space, while eliminating those join orders that violate dependency requirements, enables optimization of complex queries that include left joins and semi joins to be performed using multi-join rules. This further enhances the ability to both reduce the overall compile time and improve the plan quality of the compiled queries. Improved plan quality implies faster more efficient query execution. Improvements made to allow the use of joins that have dependencies, such as left joins, semi-joins, and anti-semi-joins, in a query optimizer are detailed below. The term semi-join will be used to refer to both semi-joins and anti-semi-joins from here on.

### Design

In one embodiment, the query optimizer can use a top down type of search engine as the platform for the optimization process. For example a Cascades search engine may be used. The Cascades search engine is described in U.S. Pat. Nos. 5,819,255 and 5,822,747, which are herein incorporated by reference. The Cascades search engine is a multi-pass, rule-based, cost-based optimization engine. The optimization search space is determined by the set of transformation and implementation rules used by the optimizer. Rules are applied recursively to the initial normalized tree transforming it into semantically equivalent query trees. The transitive closure of the rules applications defines the optimization search space. The optimizer output is a single plan with the lowest cost among all traversed plans in the search space, based on the optimizer's cost model.

To accommodate joins having dependencies in the multi-join framework, changes are necessary in the query analysis phase of the Cascades search engine. Query analysis for a multi-join framework is further disclosed in U.S. Pat. No. 7,512,600, which is herein incorporated by reference.

It should be noted that a JBB is constructed based on a left linear sequence of joins. The initial multi-join that represents the entire JBB is built based on the left linear join tree produced after the semantic query optimization phase (i.e. the parsing, binding, and normalization phase 110 of FIG. 1) that precedes the analysis phase. This has the implication that if the join tree input to the analyzer is bushy, then the bushy part becomes a JBBC of the top JBB. The bushy part will itself constitute another JBB.

In order to accommodate left-joins and semi-joins in the multi-join frame work, additional tasks are included in the query analysis phase 120 (FIG. 1) of the compiler. In addition to the previous operations, the query analysis phase also analyzes the dependencies that may occur between JBBCs. A pilot analysis is first invoked on the query tree. If pilot analysis fails then query analysis is aborted, the query analysis information is cleaned up and the multi-join rewrite of the query is not performed. Before dependency analysis was included in the query analysis step then query analysis failed when a non-inner, non-semi join was encountered. So in the past, the query was not rewritten as a multi-join operator, and the multi join rules could not be applied.

Outer joins are unique in the sense that they create output unlike other join types. The null values produced as a result of a left join are created by the join operator itself (instead of being the output of a child of the join). The null instantiated values produced by a left join have to be captured for later use during join enumeration performed by the multi-join rules. The null instantiated values are captured in the JBBC connected via a left join (i.e. the JBBC is a right child of a left join). This is done during the pilot analysis phase of the analyzer. The null instantiated output of the left join connecting a JBBC is passed as a parameter to the JBBC constructor.

Capturing and Representing Dependency Information

The dependency between JBBCs is represented using two dependency relations. Predecessor JBBCs represent the set of JBBCs that a given JBBC depends on. The set of predecessors precede the given JBBC in any join order that conforms to the dependency relationships. Successor JBBCs represent the set of JBBCs that depend on a given JBBC. For a join order to be valid, the set of successor JBBCs will be joined after the given JBBC.

Similarly, predicates associated with asymmetric joins, such as outer joins and semi joins, can be linked to dependency information. Predicates with predecessors are those predicates that relate a JBBC to its predecessors. Predicates with successors are those predicates that relate a JBBC to its successors. Note that the dependency information does not tell if a join order will have cross products. When the dependency information is satisfied then it can be assumed that a particular join subtree has a valid join order and therefore will maintain the semantics of the original query.

The dependency information can be captured during the analysis phase of the compiler. Analysis on a query tree is performed by taking the root of the query tree as the input. Analysis is performed on the query tree and the query tree is then re-written as a multi-join in the case where there are no spoiler nodes found in the query tree. An additional analysis task has been added to the list of analysis tasks previously performed as part of query analysis. The new task analyzes the dependencies between JBBCs and stores this information in the JBBC object.

The dependency analysis is performed during the analysis phase in the query analyzer. As part of the dependency analysis task mentioned above, the following tasks are accomplished: (1) join dependency analysis; (2) JBBC dependency analysis; and (3) computation of left join filter predicates. These tasks will be discussed more fully below.

Join Dependency Analysis

Join dependency analysis involves a recursive walk down the query tree. During this walk, the predicates with predecessors and predicates with successors for each JBBC are set. The join dependency analysis can be a virtual method. The base class implementation calls the JBB join dependency analysis routine for each child. The method is extended by a join class, where the actual work is performed. The method takes as a parameter the set of all predicates that cause dependency relations between JBBCs (predicates with dependencies). This includes left-outer-join predicates and semi-join predicates. These predicates are accumulated recursively down the query tree. At each join, the method JBBC::setPredsWithDependencies( ) is invoked on the JBBC representing the right child of the join. Parameters passed to the method include the predsWithDependencies. If the join is of a type that causes dependencies (i.e. left-outer-join or semi-join), then the join predicate is also passed down. JBBC::setPredsWithDependencies( ) sets the predsWithPredecessors and predsWithSuccessors for the JBBC.

After the call to the setPredsWithDependencies( ) for the right child of the join, any predicates on the current join that cause dependencies are added to the predsWithDependencies. If the join left child is not a join then setPredsWithDependencies( ) is called on the JBBC representing the left child of the join. Note that the left child of a join can never have predsWithPredecssors, since it cannot depend on any other JBBC. At the end of join dependency analysis, predicates that cause dependencies have been categorized as predsWithPredecessors and predsWithSuccessors. These values are stored in the JBBCs.

JBBC Dependency Analysis

During JBBC dependency analysis, the dependency relations between the JBBCs are computed. At the end, the predecessors and successors are computed and set for each JBBC. This is implemented by a call for each JBB in the query. This method computes the dependencies between JBBCs of a JBB and sets the predecessors and successors for each JBBC of the JBB. The computation of dependencies utilizes the predsWithPredecessors and predsWithSuccessors information set by the join dependency analysis.

Computation of Left Join Filter Predicates

Left join filter predicates are filter predicates on the left join connecting a JBBC. These predicates are not join predicates in that they do not connect the joined tables but rather sit as a filter on top of the left join. Left join filter predicates are computed for each JBBC connected via a left join. In other words, the JBBC is a right child of a left join.

Computation of the left join filter predicates involves iterating the set of JBBCs connected via a JBB. For a given JBBC connected via a left join, the join predicates between the JBBC and the rest of the JBBCs of the JBB are determined. Predicates on the left join connecting the JBBC that are not part of the join predicates determined earlier are set as the left join filter predicates in the JBBC. A simple example of a left join filter predicate is a predicate that checks for null on a column of a table that is the right side of a left join. The left join filter predicates are needed for join enumeration. For example, when creating the join for a table connected via a left join, join predicates between the JBBCs can be determined, but since filter predicates are not join predicates between any pair of JBBCs, they have to be captured in the left joined JBBC itself.

Computation of Constant Predicates with Predecessors

In some instances, some semi/anti-semi or even left joins can be written such that the join predicates don't involve any columns from the tables involved in the join. An example is below:

```
SELECT Distinct ‘J’, T0.I3, t0.i3, T0.I3
FROM d2 T0, d2 t1, d1 t2
WHERE
  ‘kTrn’ < ALL (
  SELECT ‘a’
  FROM d1 t3
  WHERE
      NOT (
      (‘DLU’ BETWEEN ( T3.i1 ) AND ( T3.I3 ))
```

Note the query has the semi-join predicate ‘kTrn’<‘a’. The predicate does not involve any columns from the joined tables, yet it filters the output from the semi-join implied by ‘kTrn’<ALL . . . . Such predicates are also captured in the JBBC.

Enumerating Join Orders that Satisfy Dependencies

Enumerating Valid Join Orders

Enumeration of joins from a multi-join is performed via the method Join * MultiJoin::splitSubset(const JBBSubset & leftSet, const JBBSubset & rightSet) const. The method takes as input a left set and a right set and creates returns that are the join between the two sets. If the left set or the right set has two or more JBBCs then the resulting join will have a corresponding multi-join as its child. However, if the left set or the right set has only one JBBC then the resulting join child will not be a multi-join, it will be whatever the JBBC represents. For example, the result may be a scan, a group by, a full outer join, or so forth. If the left set and the right set do not represent a valid split that satisfies the dependency relations then a null value is returned.

As an illustration consider the following query:

select t1.a

from

t1

inner join

t2

on t1.b=t2.b

inner join

t3

on t1.c=t3.c

This query can result in the multi-join shown in the graphical illustration shown in FIG. 5. If a splitSubset is applied to the multi-join above with the following parameters: leftSet={1, 2}; and rightSet={3}; the result will be the multi-join shown in the graphical illustration shown in FIG. 6.

When considering a valid split of a multi-join, the concept of a legal set is used. A legal set is a set of JBBCs. For each JBBC, the set contains the predecessors for that JBBC. In other words, the set contains all the JBBCs that each JBBC depends on. A split is valid if the left set is legal and the right set is legal. To allow for enumeration of left joins and semi joins, a split is also considered valid if the left set is legal and the right set is a single JBBC.

If the right set is a single JBBC connected to the JBB via a left join then the resulting join is created as a left join. If the right set is a single JBBC connected via a semi join then the resulting join is created as a semi join.

As an illustration consider the following query:

select t1.a

from

t1

left join

t2

on t1.b=t2.b

inner join

t3

on t1.c=t3.c

The query above can result in the multi-join shown in the graphical illustration shown in FIG. 5. Based on the query the following dependencies will exist:
T1
   successors: {T2}
   predecessors: { }
T2
   successors: { }
   predecessors: {T1}
T3
   successors: { }
   predecessors: { }

Based on the information above, the following are legal splits:
Split1
   leftSet={T1, T2}
   rightSet={T3}
Split2
   leftSet={T1, T3}
   rightSet={T2}
Split3
   leftSet={T3}
   rightSet={T1, T2}

Split 1 will result in an inner join. Split 2 will result in a left join since T2 is connected via a left join. Split 3 will result in an inner join. It should be noted that the plan from this split will not be left linear.

Split 1 is a valid split since the left set is legal, i.e. all the predecessors of each JBBC are present in the set and the right set is a single JBBC which does not have any dependencies. Split 2 is a valid split since the left set is legal and the right set is a single JBBC. But since T2 is connected via a left join, the join produced is a left join. Split 3 is valid since both the left set and the right set are legal.

The following splits are not valid:
Split4
   leftSet={T1}
   rightSet={T2, T3}
Split5
   leftSet={T2, T3}
   rightSet={T1}
Split6
   leftSet={T2}
   rightSet={T1, T3}

Split 4 is not valid because the right set is not legal. T2 has predecessors {T1} which are not in the set. Split 5 is not valid because the left set is not legal. T2 has predecessors {T1} which are not in the set. Split6 is not valid because the left set is not legal. T2 has predecessors {T1} which are not in the set.

Based on the rules for a valid split mentioned above, all of the different join orders that can be enumerated by the original cascade join enumeration rules (left shift and join commutativity) can be enumerated by the multi-join rules.

Adjusting the Multi-Join Rules to Enumerate Valid Join Orders

The multi-join rules are used to enumerate joins from any given multi-join. In one embodiment, there are three multi-join rules that are used to enumerate joins in a multi-join. The rules belong to two categories. In the first category is the enumeration rule, referred to as the MJEnumRule. In the second category are the star join type I rule, called the MJStarJoinIRule, and the star join type II rule, called the MJStarJoinIIRule.

The multi-join enumeration rule is a regular transformation rule that applies to a multi-join and produces several substitutes. Each substitute is a single join between different ‘splits’ of the multi-join. The enumeration rule uses the splitSubset method mentioned above to enumerate a join. In the case where an invalid split is tried, the value returned by the splitSubset is null. No substitute is inserted into the cascades memo and the enumeration rule moves on to try the next join.

The star join type I & II rules are transformation rules just like the enumeration rule. However, these rules are special in the sense that they produce a single substitute that is a join tree specified as a left linear join order. The children of the joins in the tree can be multi-joins, which means that bushy join trees are possible. The star join rules are different from the enumeration rule in that they can produce a whole left linear join sequence in a single application, whereas multiple applications of the enumeration rule will produce a whole join sequence (with the exception of a two join). These rules, like the enumeration rule, use the splitSubset method to create the joins that comprise the left linear join sequence.

However, since the star join rules produce a whole join sequence in one application, these rules cannot simply rely on the splitSubset method. The rules ensure that the join sequence produced is a valid join sequence that satisfies the dependency relations between the JBBCs. This is done before invocations to the splitSubset method to produce the actual join tree. These rules operate based on the concept of a fact table. The fact table is defined as the most expensive table to access. For example, in a star architecture, the fact table can be the center table in the star architecture that contains the most data. Additional tables can be located about the fact table.

The star join type I rule attempts to obtain a nested join plan with a good key access into the fact table. Good key access is obtained when there are not considered to be too many probes seeking to access the fact table. For example, it may be considered that there are too many probes seeking access to the fact table if it takes longer for the multiple probes to scan a portion of the fact table than it would to scan the entire fact table. If the amount of time for all of the assigned probes to scan selected portions of the fact table is less than the time it takes to scan the entire fact table, then it can be considered that there is good key access.

In the case where a good key access nested join is not possible, star join type II is applied. The star join type II rule places the fact table as the outer most join (i.e. left child of the left most join) and then performs a data flow optimization. With the ability to include left-joins and semi-joins, a JBBC can be dependent on other JBBCs. Therefore, the fact table has been altered to be the largest independent table. An independent table is defined as a table that does not have any predecessors. Thus, the largest independent table is a table for which the corresponding JBBC has an empty predecessors set.

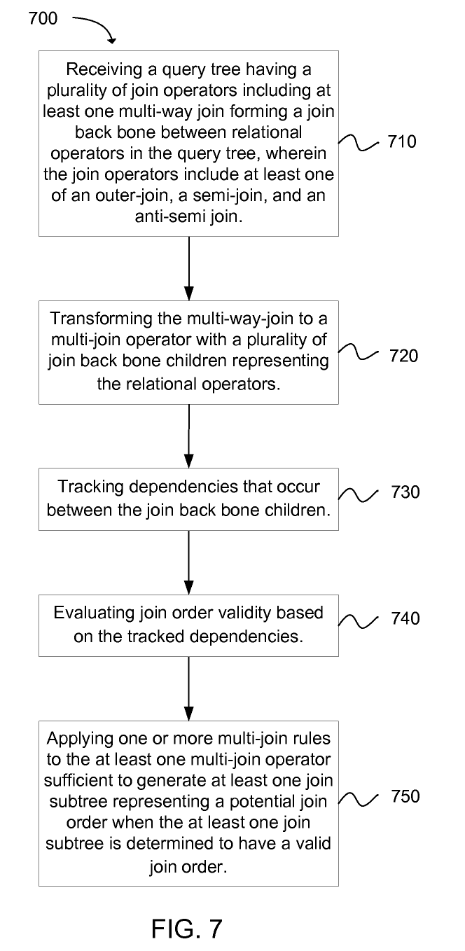

In accordance with one embodiment, a method 700 for join order optimization in a query optimizer is disclosed, as depicted in the flow chart of FIG. 7. The method includes the operation of receiving 710 a query tree having a plurality of join operators including at least one multi-way join between relational operators in the query tree. The join operators can include at least one of an outer-join, a semi-join, and an anti-semi join. The multi-way-join is transformed 720 to a multi-join operator with a plurality of join back bone children representing the relational operators. Dependencies are tracked 730 that occur between the join back bone children. Join order validity is evaluated 740 based on the tracked dependencies. When the at least one join subtree is determined to have a valid join order, one or more multi-join rules are applied 750 to the multi-join operator sufficient to generate at least one join subtree representing a potential join order.

In another embodiment, the method 700 can be accomplished using a computer or server system having one or more processors and containing one or more computer readable media. Computer readable instructions can be located on the one or more computer readable media which, when executed by the one or more processors, causes the one or more processors to implement the method for join order optimization in a query optimizer. For example, in one embodiment the method can be implemented using an enterprise data warehouse platform.

The ability to optimize queries using the multi-join rules for the class of queries that include asymmetric joins, such as left-joins and semi-joins, provides considerable advantages. The multi-join rules enable the compile time and execution time for SQL database queries to be significantly decreased. Queries that contain asymmetric joins, such as the left-joins and semi-joins, can now be converted to multi-joins to allow the query to take advantage of the multi-join rules.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for join order optimization in a query optimizer, comprising:
receiving a query tree having a plurality of join operators including at least one multi-way join forming a join back bone between relational operators in the query tree, wherein the join operators include at least one of an outer-join, a semi-join, and an anti-semi join;
transforming the multi-way-join to a multi-join operator with a plurality of join back bone children representing the relational operators;
tracking dependencies that occur between the join back bone children;
evaluating join order validity based on the tracked dependencies; and
applying one or more multi-join rules to the at least one multi-join operator sufficient to generate at least one join subtree representing a potential join order when the at least one join subtree is determined to have a valid join order.

2. The method of claim 1, wherein tracking dependencies further comprises assigning to each join back bone child (JBBC) having a dependency:
a set of predecessor JBBCs that a given JBBC depends on; and
a set of successor JBBCs that depends on the given JBBC.

3. The method of claim 2, further comprising performing a recursive analysis of the query tree to assign each of the JBBCs having dependencies a set of predicates with predecessors and a set of predicates with successors.

4. The method of claim 3, further comprising analyzing the predicates with predecessors and the predicates with successors to determine dependencies between the JBBCs of the JBB.

5. The method of claim 4, further comprising calculating a left join filter predicate for each JBBC connected via a left joined JBBC, and storing the left join filter predicate in the associated left joined JBBC to enable join enumeration.

6. The method of claim 1, wherein applying one or more multi-join rules to the multi-join operator sufficient to generate at least one join subtree when the at least one join subtree is determined to have a valid join order further comprises applying an enumeration rule to the query tree to form a split subset to generate the at least one join subtree.

7. The method of claim 6, further comprising returning a null value when the split subset is an invalid split such that no subtree is formed.

8. The method of claim 1, wherein applying one or more multi-join rules to the multi-join operator sufficient to generate at least one join subtree when the at least one join subtree is determined to have a valid join order further comprises obtaining a nested join plan having a good key access to a fact table to form a whole left linear join sequence to the query tree having a valid join order.

9. The method of claim 8, further comprising placing the fact table as the left child of the left most join when obtaining the good key access to the nested join is not possible.

10. A computer-implemented method, comprising:
receiving a query tree for a query, the query tree having at least one multi-way join forming a join back bone between relational operators, wherein the join operators include at least one asymmetric join;
transforming the multi-way-join to a multi-join operator with a plurality of join back bone children representing the relational operators;
tracking dependencies that occur between the join back bone children; and
applying one or more multi-join rules to the multi-join operator, when the at least one join subtree is determined to have a valid join order based on the tracked dependencies, sufficient to generate at least one join subtree representing a potential join order.

11. The method of claim 10, wherein tracking dependencies further comprises assigning to each join back bone child (JBBC) having a dependency:
a set of predecessor JBBCs that a given JBBC depends on; and
a set of successor JBBCs that depends on the given JBBC.

12. The method of claim 11, further comprising performing a recursive analysis of the query tree to assign each of the JBBCs having dependencies a set of predicates with predecessors and a set of predicates with successors.

13. The method of claim 12, further comprising analyzing the predicates with predecessors and the predicates with successors to determine dependencies between the JBBCs of the JBB.

14. The method of claim 13, further comprising calculating a left join filter predicate for each JBBC connected via a left joined JBBC, and storing the filter predicate in the associated left joined JBBC to enable join enumeration.

15. A system comprising:
one or more processors;
one or more computer readable media:
computer readable instructions on the one or more computer readable media which, when executed by the one or more processors, cause the one or more processors to implement a method for join order optimization in a query optimizer comprising:
receiving a query tree having a plurality of join operators including at least one multi-way join between relational operators in the query tree, wherein the join operators include at least one of an outer-join, a semi-join, and an anti-semi join;
transforming the multi-way-join to a multi-join operator with a plurality of join back bone children representing the relational operators;
tracking dependencies that occur between the join back bone children;
evaluating join order validity based on the tracked dependencies; and
applying one or more multi-join rules to the multi-join operator sufficient to generate at least one join subtree representing a potential join order when the at least one join subtree is determined to have a valid join order.

16. The system of claim 15, wherein tracking dependencies further comprises assigning to each join back bone child (JBBC) having a dependency:
a set of predecessor JBBCs that a given JBBC depends on; and
a set of successor JBBCs that depends on a given JBBC.

17. The system of claim 16, further comprising performing a recursive analysis of the query tree to assign each of the JBBCs having dependencies a set of predicates with predecessors and a set of predicates with successors.

18. The system of claim 17, further comprising analyzing the predicates with predecessors and the predicates with successors to determine dependencies between the JBBCs of the JBB.

19. The system of claim 18, further comprising calculating a left join filter predicate for each JBBC connected via a left joined JBBC, and storing the filter predicate in the associated left joined JBBC to enable join enumeration.

20. The system of claim 15, wherein applying one or more multi-join rules to the multi-join operator sufficient to generate at least one join subtree when the at least one join subtree is determined to have a valid join order further comprises applying an enumeration rule to the query tree to form a split subset to generate the at least one join subtree.
